(19) United States
(12) Patent Application Publication
(10) Pub. No.: US 2011/0108621 A1
(43) Pub. Date: May 12, 2011

(54) National security driver's license

(76) Inventor: Vinod M. Grover, Carrollton, GA (US)

(21) Appl. No.: 12/591,112

(22) Filed: Nov. 9, 2009

(51) Int. Cl. G06K 19/06; G06F 19/00

(52) U.S. Cl. 235/380; 235/493

(57) ABSTRACT

An improvement upon a driver's license, a national driver's license includes traditional identification information as well as insurance, both automobile and health, automobile registration, health care, emergency contact, driving records, criminal record, credit and banking, and employment information either embedded thereupon or information that may be used to access one or more computer systems containing said information.

### CITATION TO RELATED APPLICATIONS

This application claims priority to, and is entitled to the filing date of, the U.S. Provisional Patent Application No. 61/203,290, filed Dec. 22, 2008. No new matter has been added to the specification.

### BACKGROUND OF THE INVENTION

1. Field of the Technology

This invention relates, generally, to the field of identification of individuals and storage of their personal information, and, more specifically, to an improvement over traditional state driver's licenses or identification cards for a uniform, standardized identification supported by a platform for an information storage system.

2. Background

The information typically provided on a standard driver's license is regulated by each individual state to provide basic information about the driver and any other information required by the state to allow the driver to operate a vehicle in that particular state. The license may also carry information regarding restrictions on it, such as requiring the individual to wear contacts or eyeglasses, additional licenses, such as a motorcycle or commercial license, or that the individual is an organ donor. In most states, a driver has to separately carry proof of automobile liability insurance, which frequently comes in the form of a second card. Even if a driver has such insurance, he or she may not have the proper documentation

There are additional types of information that would be very useful to law enforcement and emergency personnel, however, that are not included on a typical driver's license, or, if they are, are not of a uniform or standard type to allow access in any state. For example, many drivers and individuals have specific health or other problems that are problematic or life threatening to the individual in emergency situations or may be dangerous or harmful to emergency and rescue personnel. Examples of such problems are heart disease or other problems, diabetes, asthma, allergies to medications or other materials, and many other possible complications. Additionally, information regarding whom to contact in an emergency, such as employment or family information, and medical insurance information may be difficult to locate in an emergency. Locating and applying such information can be a matter of life and death when only seconds count.

It is advantageous to have a single, standardized and uniform national identification card that will function as a driver's license, if the individual is a licensed driver, and personal information and identification card. Such a national driver's license may be used as an enhanced driver's license or passport including for air, rail, and sea travel as well as for accommodations; identification in government buildings, retailers, and banks; to contain emergency, insurance, or other contact information at places of employment, hospitals, or by emergency officials; and may be used by any number of other organizations or institutions for identity and/or security checks.

In addition to identifying information contained on most state driver's licenses, such a national driver's license may have information encoded on a magnetic strip, such as insurance, driving record or restrictions, health, criminal record or any special alerts, a weapon permit, and information specific to authenticating credit card or personal check purchases. It would be advantageous to have such a card embedded with such information, preferably on a magnetic strip, that is in a standardized, uniform format that may be read by a magnetic card reader. The magnetic card reader would preferable be connected to a system, network, or other database via a telecommunications link, allowing access to various systems and databases necessary to store and retrieve the information discussed herein. It will be understood by one of ordinary skill in the art that such computer systems, networks, and databases may have innumerable combinations and permutations and may be arranged however is best for the network. Confidential information either embedded on the national driver's license or that must be accessed through the network may only be accessed by a specially configured and programmed card reader and may be displayed only to authorized law enforcement personnel or other authorized individuals.

The invention, described in more detail below, provides a National Security Driver's License that is standardized and uniform and provides an enabling system in order for various types of information to be accessed by law enforcement, emergency and rescue responders, and other authorized personnel. Such a system would be uniform across state lines and provide ease of access to information to the individual, law enforcement, and emergency responders.

### SUMMARY

In accordance with the present invention, a preferred embodiment provided is a national driver's license consisting of a plastic card sized substantially as a credit card or traditional driver's license such that it may in a standard wallet or card carrier having a photograph of an individual an address or other identifying information disposed on its front surface and a magnetic strip capable of being read by a magnetic stripe reader and capable of storing electronic information disposed along its back surface.

A further embodiment of the present invention comprises electronic information stored on said magnetic stripe comprising automobile insurance information.

A further embodiment of the present invention comprises electronic information stored on said magnetic stripe comprising automobile registration information.

A further embodiment of the present invention comprises electronic information stored on said magnetic stripe comprising emergency contact information.

A further embodiment of the present invention comprises electronic information stored on said magnetic stripe comprising health insurance information

A further embodiment of the present invention comprises electronic information stored on said magnetic stripe comprising criminal record information.

A further embodiment of the present invention comprises electronic information stored on said magnetic stripe comprising driving record information.

A further embodiment of the present invention comprises electronic information stored on said magnetic stripe comprising criminal record information.

A further embodiment of the present invention comprises electronic information stored on said magnetic stripe comprising credit information.

A further embodiment of the present invention comprises electronic information stored on said magnetic stripe comprising banking information.

A further embodiment of the present invention comprises electronic information stored on said magnetic stripe comprising employment information.

A further embodiment of the present invention comprises a system for implementing a national driver's license, comprising a national driver's license card; a magnetic card reader capable of reading information from a magnetic stripe disposed upon said national driver's license card; a centralized computer system in communication with said magnetic card reader, said centralized computer in communication with at least one additional computer system.

A further embodiment of the present invention comprises a photograph of the individual identified by said license.

A further embodiment of the present invention comprises having identification information for said individual identified by said license.

A further embodiment of the present invention comprises identification information including at least address and date of birth.

A further embodiment of the present invention comprises a magnetic stripe disposed upon said national driver's license card containing information readable by said magnetic stripe reader providing information necessary to access to said additional computer systems.

A further embodiment of the present invention comprises a magnetic stripe disposed upon said national driver's license card containing identification information readable by said magnetic stripe reader.

A further embodiment of the present invention comprises magnetic stripe containing identification, health insurance, automobile insurance, driving records, criminal record information, credit information, or employment information.

A further embodiment of the present invention comprises at least one additional computer system that may have stored therein identification, health insurance, automobile insurance, driving records, criminal record information, credit information, or employment information.

### BRIEF DESCRIPTION OF THE DRAWINGS

FIG. 1 is an exemplary, front view rendering of a prior art Driver's License of the State of Georgia.

FIG. 2 is an exemplary, back view rendering of a prior art Georgia Driver's License showing an informational strip.

FIG. 3 is an exemplary, front view rendering of a National Security Driver's License showing information that may be included additional to that included on a traditional state driver's license.

FIG. 4 is an exemplary, rear view rendering of a National Security Driver's License showing an electro-magnetic strip.

FIG. 5 is an exemplary, front view rendering of a National Security Driver's License showing information that may be included additional to that included on a traditional state driver's license and of smaller size that it may be attached to a key ring.

FIG. 6 is an exemplary, rear view rendering of a National Security Driver's License showing an electro-magnetic strip and of smaller size that it may be attached to a key ring.

FIG. 7 is a rendering of an exemplary network of computers that would connect to serve the informational needs of the National Driver's License.

FIG. 8 is an exemplary magnetic strip reading device that is capable of reading the information from the National Security Driver's License.

### DETAILED DESCRIPTION OF EXEMPLARY EMBODIMENTS

Turning now to the Figures, FIG. 1 is a prior art rendering of a typical driver's license 100 issued by a state government. In this case, it is a rendering of a driver's license 100 from the State of Georgia. The front of the license has disposed thereon certain identifying information 102, such as an individual's name, address, date of birth, and driver's license number. Such a license commonly includes a physical description of the individual, including a photograph 104 and information 106 describing height, weight, and eye color. Additional information 108 may include a class or type of license issued to the individual.

FIG. 2 is a prior art rendering of the back of a typical driver's license 100. Some such licenses may also have information, such as a fingerprint, disposed along the back of the card. Such information may be included on a bar code or other strip 202. The type of information included is not uniform across states, though, nor is such information uniformly or easily accessible. Additionally, such a prior art system may not be tied across multiple systems, therefore reducing any usefulness because of its limited purpose and availability.

FIG. 3 is an exemplary front view of the front of a National Security Driver's License 300, which is a preferred embodiment of the invention. A National Security Driver's License will include uniform and standardized information. In addition to the information traditionally included on a state driver's license, the National Security Driver's license, which is a preferred embodiment of the invention, may also include automobile and insurance information 302. Most states require drivers to carry automobile insurance and proof of it, but there are many occasions in which such information is not available or the driver does not have it in his or her possession. Additionally, drivers from different states may not carry the same insurance information. The National Security Driver's License 300 may also include automobile identification and insurance information 302 that will be accessible and readable to law enforcement agencies nationwide.

FIG. 4 is an exemplary rear view of a National Security Driver's License 300, which is a preferred embodiment of the invention. FIG. 4 shows a magnetic stripe 402, which contains standardized, uniform information. Such information may include identity information, insurance information, emergency contact information, automobile registration information, health and health insurance information, driving and criminal records, and other information such as employment and financial data. Alternatively, the magnetic stripe 402 may be encoded with encryption or other information that is readable by a magnetic card reader, which allows access to information stored on the card or within connected computer systems by law enforcement or other authorized personnel.

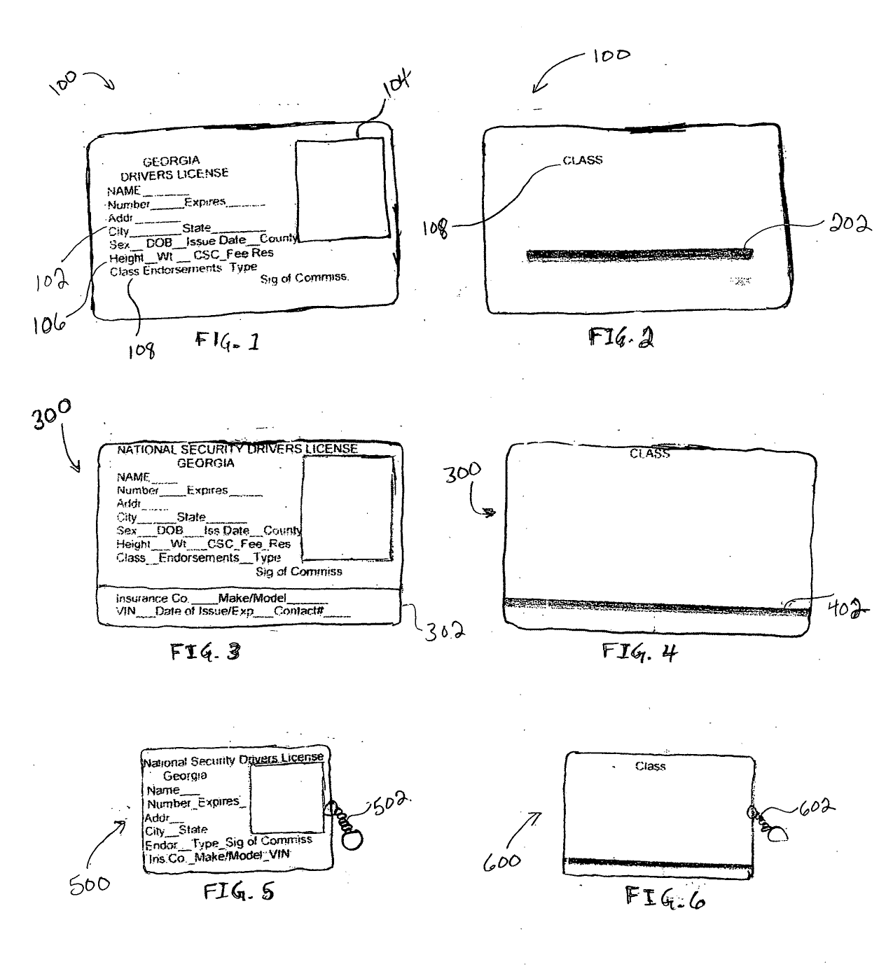

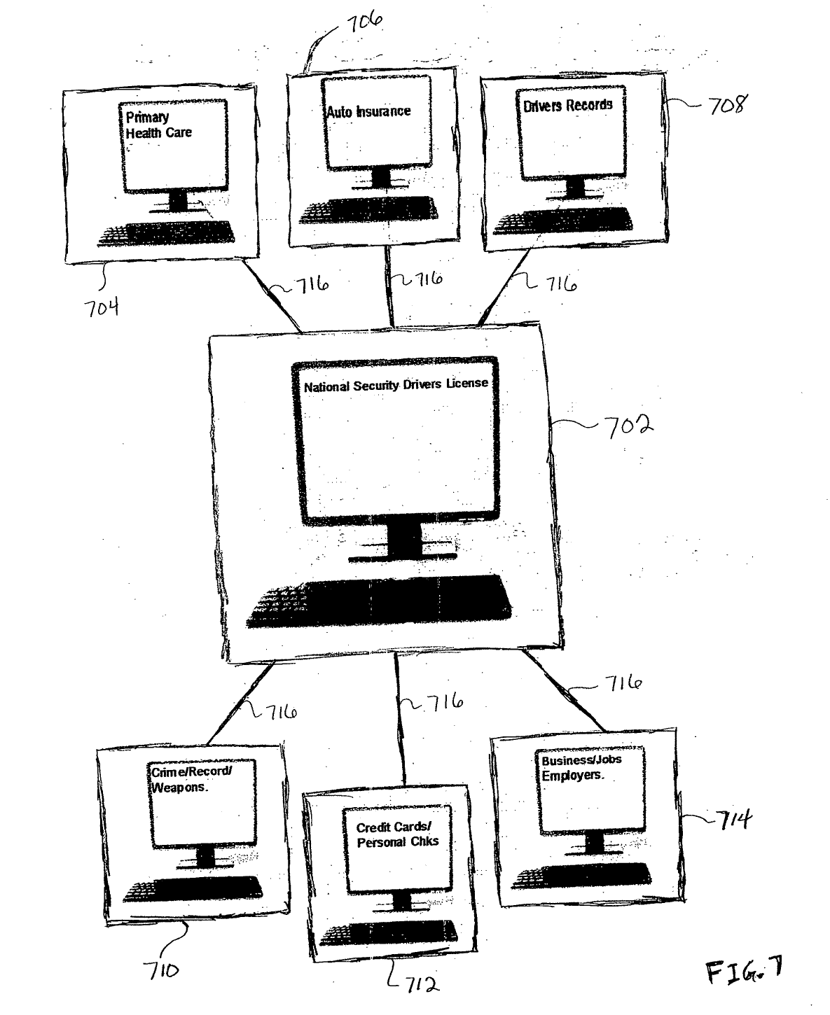

FIG. 5 is a front view of an exemplary embodiment of the National Security Driver's License 500 of the invention, sized such that it may be attached to a standard sized key ring 502. FIG. 6 is a rear view of the exemplary embodiment sized to fit on a key ring, including an information-encoded magnetic stripe 602 as discussed above. It will be understood to one of ordinary skill in the art that the same information provided and included on the card shown in FIGS. 5 and 6 is the same as described above in FIGS. 3 and 4.

FIG. 7 is a diagram of the multiple computer systems that may be connected to enable the functionality of the National Security Driver's License. A centralized computer or computer system 702 that contains a database of information to enable the National Security Driver's License 200. It will be understood by one of ordinary skill in the art that such a computer system and database may be made up of one large computer or database or of multiple databases distributed over multiple computers or a large network. Such a centralized database does not necessarily include all information used in the National Security Driver's License system. The database or system may be connected to other informational systems. These systems may include a system containing health care information 704, a system containing automobile insurance information 706, a system containing driving record information 708, a system containing criminal records and/or weapons permits 710, credit and baking information 712, and employment, business and/or emergency contact information 714. It will be understood of ordinary skill in the art that these systems may be interconnected via network and telecommunications links 716. Additionally, one of ordinary skill in the art will understand that only law enforcement and other authorized personnel and individuals may access confidential information contained on the card and in the systems.

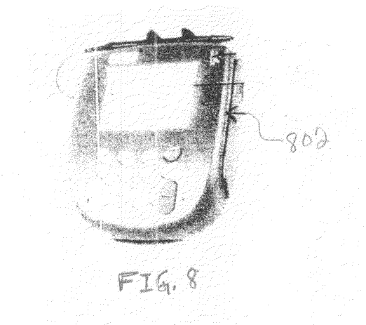

The information either contained on the card or used to access information in the computer system or systems described may be accessed via a magnetic card reader 802 shown in FIG. 8. It will be understood by one of ordinary skill in the art that the card reader 802 may be connected to the centralized computer system 702 through any number of telecommunications means, including traditional telephone lines, Ethernet or other Internet communications, broadband cable, fiber optic, or any other communications means.

What is claimed is:

1-9. (canceled)

10. A national driver's license consisting of
a plastic card sized substantially as a credit card or traditional driver's license such that it may in a standard wallet or card carrier having a photograph of an individual an address or other identifying information disposed on its front surface and a magnetic strip capable of being read by a magnetic stripe reader and capable of storing electronic information disposed along its back surface.

11. The national driver's license of claim 10, electronic information stored on said magnetic stripe comprising automobile insurance information.

12. The national driver's license of claim 10, electronic information stored on said magnetic stripe comprising automobile registration information.

13. The national driver's license of claim 10, electronic information stored on said magnetic stripe comprising emergency contact information.

14. The national driver's license of claim 10, electronic information stored on said magnetic stripe comprising health insurance information

15. The national driver's license of claim 10, electronic information stored on said magnetic stripe comprising criminal record information.

16. The national driver's license of claim 10, electronic information stored on said magnetic stripe comprising driving record information.

17. The national driver's license of claim 10, electronic information stored on said magnetic stripe comprising criminal record information.

18. The national driver's license of claim 10, electronic information stored on said magnetic stripe comprising credit information.

19. The national driver's license of claim 10, electronic information stored on said magnetic stripe comprising banking information.

20. The national driver's license of claim 10, electronic information stored on said magnetic stripe comprising employment information.

21. A system for implementing a national driver's license, comprising
a national driver's license card;
a magnetic card reader capable of reading information from a magnetic stripe disposed upon said national driver's license card;
a centralized computer system in communication with said magnetic card reader, said centralized computer in communication with at least one additional computer system.

22. The system of claim 21, wherein said national driver's license card further comprises a photograph of the individual identified by said license.

23. The system of claim 21, wherein said national driver's license card further comprises having identification information for said individual identified by said license.

24. The system of claim 23, wherein said identification information includes at least address and date of birth.

25. The system of claim 21, wherein said magnetic stripe disposed upon said national driver's license card contains information readable by said magnetic stripe reader providing information necessary to access to said additional computer systems.

26. The system of claim 21, wherein said magnetic stripe disposed upon said national driver's license card contains identification information readable by said magnetic stripe reader.

27. The system of claim 21, wherein said information disposed upon said magnetic stripe may be identification, health insurance, automobile insurance, driving records, criminal record information, credit information, or employment information.

28. The system of claim 21, wherein at least one additional computer system may have stored therein identification, health insurance, automobile insurance, driving records, criminal record information, credit information, or employment information.
